(19) United States
(12) Patent Application Publication
(10) Pub. No.: US 2008/0123893 A1
(43) Pub. Date: May 29, 2008

(54) Eyeglass frame assembly

(75) Inventor: Ming-Shuang Lee, Tainan City (TW)

Correspondence Address: BIRCH STEWART KOLASCH & BIRCH, PO BOX 747, FALLS CHURCH, VA, 22040-0747, US

(73) Assignee: Inter Brands Co.

(21) Appl. No.: 11/604,380

(22) Filed: Nov. 27, 2006

(51) Int. Cl. H04R 25/00

(52) U.S. Cl. 381/376

(57) ABSTRACT

An eyeglass frame assembly is provided, wherein a music generator is disposed on each of two temples of an eyeglass frame, an earphone jack is disposed on the music generator, for the earphone plugs of a mono earphone and a stereophonic earphone to selectively plug in. Through this design, the user can select to use the mono earphone or the stereophonic earphone according to personal demands, so as to talk on a phone call or enjoy the high quality stereo sound effects.

### BACKGROUND OF THE INVENTION

1. Field of Invention

The invention relates to an eyeglass frame assembly, and more particularly, to an eyeglass frame with a music generator being disposed on each of the two temples respectively, and with earphone jacks being disposed on the two music generators respectively, for a stereophonic earphone and a mono earphone to plug in correspondingly.

2. Related Art

As the rapid development of the industrial society, the modern people have an increasingly high demand for the life quality and quality of goods. Taking the eyeglasses as an example, in the earlier days, only the usage functions of correcting vision, isolating strong lights or preventing flying objects from entering into the eyes are required, but nowadays, besides the practical functions of correcting vision and protecting the eyes, other special and competitive functions are also required, so as not to be gotten rid of from the market. Thus, all the eyeglasses manufacturers focus on developing eyeglasses with novel structures to skip the traditional style and effect of the conventional eyeglasses, in order to survive in the market.

Accordingly, some of the manufactures have disposed a music generator (e.g., MP3) on the frame of the eyeglasses, and a leading wire of an earphone is fixedly connected to the music generator, such that when the user listens to the music, the earphone is directly worn at the ears. However, as the earphone is directly fixed on the music generator, the user cannot select to wear a mono earphone or a stereophonic earphone according to user's favor. In addition, when the user needs to answer a call while wearing the stereophonic earphone, the stereophonic earphone on one ear must be taken off, so that not only the high quality of the stereo surround sound field is lost, and the user cannot enjoy the music clearly; and if using the mono earphone, the user cannot enjoy the perfect music of the stereo surround sound effect either.

Therefore, in view of the above defects, based upon the spirit and concept of being perfect, the applicant exerts his effects and cooperates with other ideas, together with the experience, techniques, knowledge in manufacturing and designing, thereby finally creating the invention.

### SUMMARY OF THE INVENTION

The invention relates to eyeglass frame assembly, which is convenient for the user to selectively use a mono earphone to answer a call or use a stereophonic earphone to enjoy high quality stereo sound effects of music while wearing an eyeglass with music generators, wherein earphone jacks are disposed in the music generator, for the earphone plug of the mono earphone or the stereophonic earphone to selectively plug in.

The invention enables the user to select the mono earphone to enjoy the music while talking on a phone call or select the stereophonic earphone to enjoy the perfect music with stereo surround sound effect, depending upon the user's personal demands.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given herein below for illustration only, and thus is not limitative of the invention, and wherein:

FIG. 1 is a stereogram (I) of the invention;

FIG. 2 is a stereogram (II) of the invention; and

FIG. 3 is a side view of the invention.

### DETAILED DESCRIPTION OF THE INVENTION

To clearly and comprehensively disclose the technical content, object, and efficacy of the invention, the invention is illustrated below in great detail with reference to the figures and referential numerals.

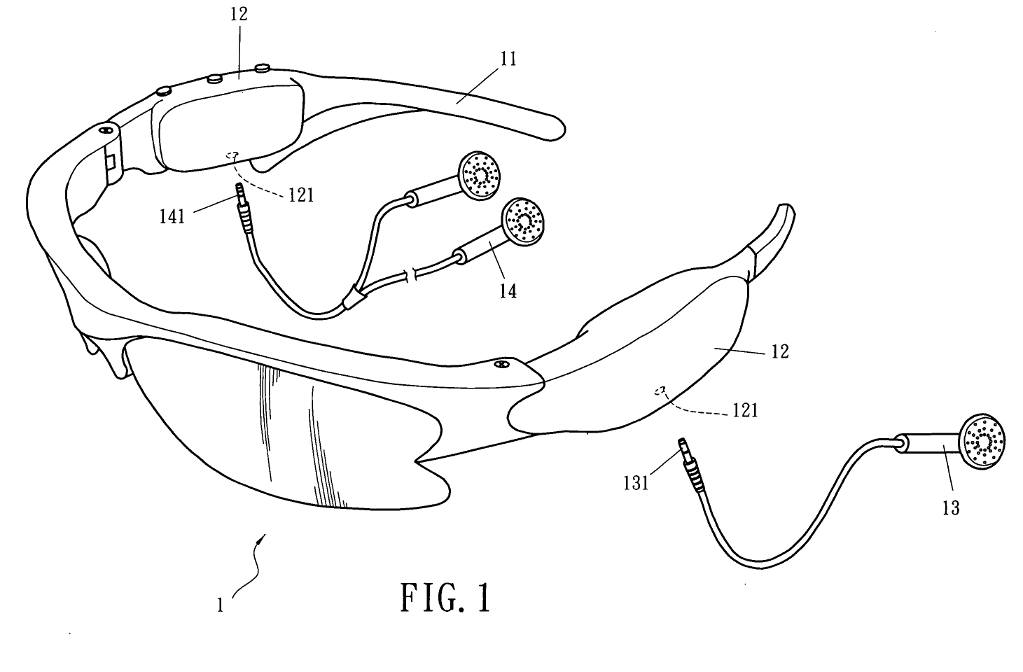

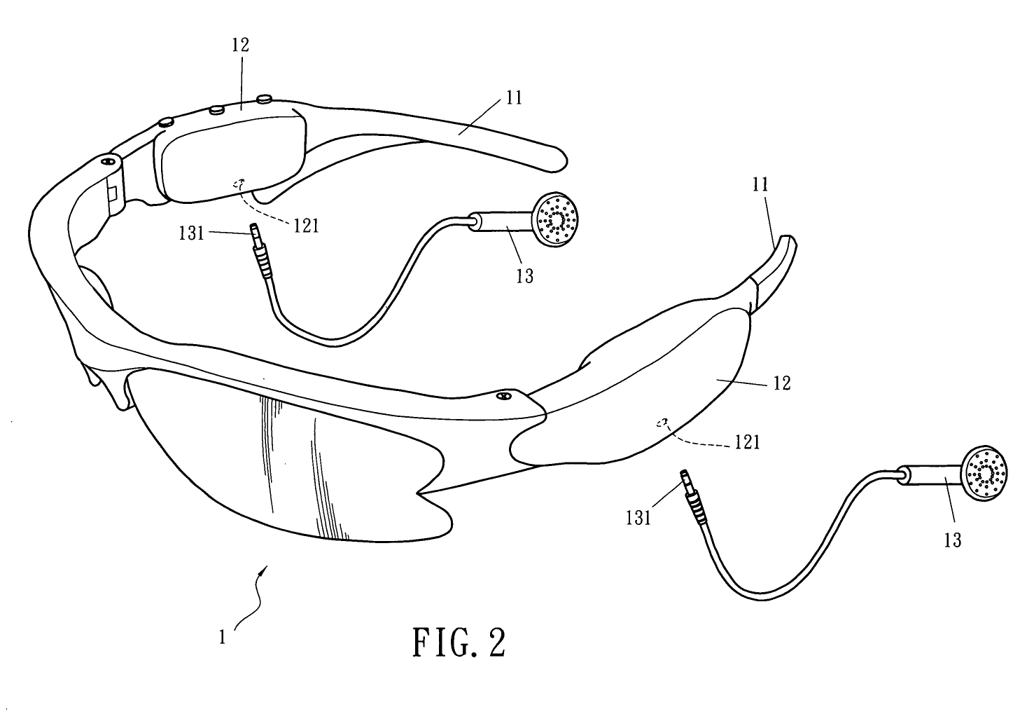

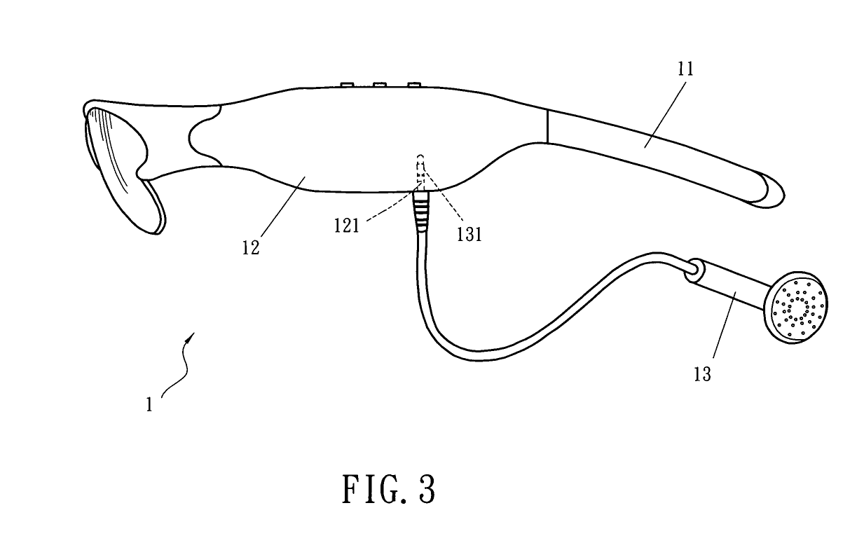

As shown in FIGS. 1 to 3, the eyeglass frame assembly of the invention is shown. A music generator 12 such as MP3 player is disposed on each of the two temples 11 of the eyeglass frame 1, and an earphone jack 121 is disposed in the music generator 12, for the earphone plug 131 of a mono earphone 13 or the earphone plug 141 of a stereophonic earphone 14 to selectively plug in. Definitely, a single music generator 12 such as MP3 is disposed on one of the temples 11, and an earphone jack 121 is disposed in the music generator 12, for the earphone plug 131 of the mono earphone 13 or the earphone plug 141 of the stereophonic earphone 14 to selectively plug in.

Based upon this design, when the user wants to enjoy music while he/she is walking or doing exercises so as to relieve the pressure in life and to calm down the mood, the user may wear an eyeglass frame 1 of the invention, and selects to use the mono earphone 13 or the stereophonic earphone 14. When the user wants to make a phone call while enjoying the music, the user may select to wear the mono earphone 13 that is plugged in one of the music generator 12 of the eyeglass frame 1 on his/her ear, in this way, the user is capable of enjoying the music on one ear and answering a call on the other ear.

Furthermore, when the user wants to be deeply involved in the perfect music with stereo surround sound effect, he/she may select to wear the stereophonic earphone 14 on both ears, thereby merely enjoying the wonderful music.

As known from the above structure and the implementation, the invention has the following advantages.

1. The invention disposes a music generator on the temple of an eyeglass frame, and a earphone jack is disposed in the music generator, such that the mono earphone or the stereophonic earphone may be removably plugged in the music generator, which is suitable for the user to use depending upon the real demands.

2. The invention may plug in a mono earphone correspondingly into the earphone jack disposed in the music generator of the eyeglass frame, in such a manner, the user is capable of wearing an earphone on one ear to enjoy the music, and answering the call at any time via the other ear, without interfering with each other.

3. The invention may plug in a stereophonic earphone correspondingly into the earphone jack disposed in the eyeglass frame, in such a manner, the user is capable of enjoying the wonderful music with stereo surround effect while wearing the stereophonic earphone on both ears.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An eyeglass frame assembly, wherein a music generator is disposed on each of two temples of an eyeglass frame, and an earphone jack is disposed in the music generator for an earphone to selectively plug in.

2. The eyeglasses as claimed in claim 1, wherein the earphone is a mono earphone.

3. The eyeglasses as claimed in claim 1, wherein the earphone is a stereophonic earphone.

4. An eyeglass frame assembly, wherein a music generator is disposed on one of two temples of an eyeglass frame, and an earphone jack is disposed on the music generator for an earphone to selectively plug in.

5. The eyeglasses as claimed in claim 4, wherein the earphone is a mono earphone.

6. The eyeglasses as claimed in claim 4, wherein the earphone is a stereophonic earphone.
